(19) United States
(12) Patent Application Publication
(10) Pub. No.: US 2005/0208167 A1
(43) Pub. Date: Sep. 22, 2005

(54) Die set of molding extruder for tire with slanted conductive ring

(76) Inventors: Jeong-Sun You, Gwangiu (KR); Il-Taik Jung, Gwangiu (KR); Chi-Hoon Cho, Gwangiu (KR); Hun-Seon Baik, Gwangiu (KR)

Correspondence Address: MARTINE PENILLA & GENCARELLA, LLP, 710 LAKEWAY DRIVE, SUITE 200, SUNNYVALE, CA, 94085, US

(21) Appl. No.: 10/971,677

(22) Filed: Oct. 22, 2004

(30) Foreign Application Priority Data
Nov. 4, 2003 (KR) 2003-0077706

(51) Int. Cl. B29C 47/06

(52) U.S. Cl. 425/133.5

(57) ABSTRACT

A mold extruder for a tire with a highly electrically conductive ring and a manufacturing method using the same. The extruder solves the problem of static electricity caused by failure to discharge charges generated in a vehicle body, to the ground, but accumulating charges on the tire when a large amount of silica is used into the tread rubber composition of a tire. The mold extruding die for forming a conductive ring on the tread extrudes a cap tread, an under tread, and tread wings simultaneously, is installed to a head section of a mold extruder having a tri-extruder for extruding a tire tread, and includes a preform die, a final die, and a cassette. The extruding passages for the cap tread, the under tread, and the tread wings are formed by assembling the preform die, the final die, and the cassette. By designing a conductive ring passage for the extruding passage of the under tread to penetrate the extruding passage of the cap tread, the under tread rubber composition protrudes so as to divide a space of the cap tread extruding passage by the conductive ring passage penetrating the cap tread into a right-side space and a left-side space. For the purpose of easily protruding the under tread rubber composition to an upper end of the cap tread through the conductive ring passage, a triangular recess on a ceiling of the under tread extruding passage penetrates the cap tread extruding passage from a rear side to a front side is formed.

### BACKGROUND OF THE INVENTION

1. Field of the Invention

The present invention relates to a die set of a molding extruder for a tire, and more particularly to a die set of a molding extruder for a tire with a tread formed with a slanted conductive ring made of a rubber composition containing a conductive material such as carbon black in order to discharge static electricity charged on the tire having a cap tread containing silica.

2. Description of the Related Art

Recently, the importance of environmental pollution has increased, and restriction of pollution by a vehicle and saving of fuel are presented as primary problems to be solved. For these reasons, tire manufacturers are making efforts to manufacture a tire having characteristics of low rotational resistance, excellent braking performance on a dry road, a wet road, and an icy road, excellent frictional resistance, and low driving noise.

For the above, a tire having a cap tread containing silica as a reinforcing filler has been proposed in EPA501227 The present invention relates to a tire manufactured by molding a tire tread with a rubber composition containing a large quantity of non-conductive filler such as silica or low carbon black content as filler. More particularly, the present invention relates to an extruding process and an extruder designed to manufacture such a tire. Application of a large quantity of silica as a reinforcing filler onto a tire cap tread has the advantage of improving braking performance on pavement and remarkably reducing rotational resistance lowering fuel efficiency, so that silica is advantageously used in the rubber composition of the tire cap tread. However, since silica is a non-conductive material, static electricity generated by friction between a tire and pavement and static electricity generated from a vehicle body cannot be discharged through the ground but instead accumulate within the vehicle when it is in motion.

The accumulated static electricity not only discharged to the ground but also gives an unpleasant shock to a passenger in the vehicle when he/she contacts the vehicle body but may also accelerate tire aging. Moreover, there is risk of deterioration of performance of electronic devices provided in the vehicle and fears over fire and explosion due to sparks generated when refueling at a gas station. In order to employ the advantages the silica rubber composition applies to the tire cap tread, the problem of the static electricity should be solved. To solve this problem, since silica alone cannot be used, a carbon black, which has excellent conductivity in comparison with that of the silica, may be used. In this case, the advantages in performance seen when the silica filler is added will be reduced. Electric conductivity is measured as volume resistivity (Ωcm) (ASTM D-257). Generally, if a finished product has a volume resistivity equal to or less than 10⁸ Ωcm, electricity is not accumulated therein. The rubber composition with a large quantity of silica as a filler usually has a volume resistivity within the range of 10¹³ Ωcm-10¹⁵ Ωcm, and if the carbon black is used in an amount of 30 parts by weight or more, based on 100 parts by weight of the rubber, the volume resistivity is under 10⁸ Ωcm, which is a value sufficient for discharging static electricity. However, if carbon black is added to the rubber composition of the cap tread contacting the pavement in more than 30 parts by weight, since the amount of silica is relatively reduced, the performance of the cap tread is weakened. Hence, several tire manufactures and inventors have filed patent applications for the static electricity discharging technologies relating to a tire made of the rubber composition tire using silica.

EP 0658452A1 and EP 0732229B1 propose a method for discharging static electricity. According to this method, a conductive rubber mixture (a composition with a proper carbon black filler content to provide conductive performance) is used to form a tread cover strip which is disposed at over the entire contour or part of the tread. EP0658452, U.S. Pat. No. 5,518,055, and JP834204 propose a method for inserting a thin conductive rubber sheet between a tread shoulder and a side. The above proposals have drawbacks that since using the silica, the tread performance cannot be achieved when the entire contour of the tread is covered with the conductive rubber mixture, and another problem can arise due to abnormal abrasion caused based on difference of abrasion degrees of different rubber compositions when the conductive rubber sheet is inserted.

A composition adding method for providing conductivity to an insulative silica rubber composition by addition of highly conductive carbon black, or other material (aluminum powder or carbon fiber) in a predetermined amount or more has been proposed. According to this second method, since another material is added, the cost of materials increases and the performance of the silica composition is deteriorated.

A third method is for providing a tread contacting road with a slanted conductive ring to discharge static electricity. In other words, there is provided a tire having band-shaped or plate-shaped conductive rings penetrating from an under tread to a cap tread, which is a tire for effectively discharging static electricity accumulated on the under tread to the ground through the conductive ring. The conductive ring perpendicularly penetrates the cap tread so as to be at a right angle to the ground, so that the conductive ring may be separated from the tread rubber due to a load when a vehicle travels linearly or turns, and the abnormal abrasion may deteriorate the performance of a tire.

The inventor has invented a tire having a tread with a slanted conductive ring to overcome the drawbacks of a tire having a vertical conductive ring perpendicular to the ground and has filed a patent application (now registered in Korean Patent No. 396486).

There are various proposals to extrude a tread of a tire having a conductive ring. EP 0718127 discloses a technology for molding a conductive ring on a tread by joint molding such as injection molding in order to provide a conductive ring for discharging static electricity. WO99/43505 (KR 2001-041285A) discloses a tread extruder and method of using a roll-type extruder having a separated micro-extruding head for molding a conductive ring during extrusion of a tread. As described above, according to a conventional manufacturing method for molding a conductive ring on a tread for discharging static electricity, since additional processes and new devices are required, the manufacturing costs should are inherently increased. Since additional processes are required and the processes are complicated, the productivity is deteriorated. Moreover, as described above, though various proposals are disclosed in several inventions for discharging static electricity of a tire having a cap tread using the silica rubber composition, the above inventions do not describe the manufacturing process sufficiently.

### SUMMARY OF THE INVENTION

Therefore, the present invention has been made in view of the above and/or other problems, and it is an aspect of the present invention to improve the productivity through a simple process and to obtain more effective static electricity discharging performance.

It is another aspect of the present invention to provide a die set of a molding extruder for preventing the steady operation from deterioration by restraining separation of cap tread rubber of a conductive ring due to frictional stress against the ground without deterioration of wear resistance as well as low fuel efficiency of a tire, and molding a conductive ring of a tire tread with a slant to easily discharge static electricity. According the above aspects, in comparison with the conventional art, the present invention is different in that the manufacturing method is simplified and convenient without increasing the manufacturing costs, and the conductive ring is formed by guiding rubber flow in order for an under tread to penetrate a cap tread by modifying a preform die of a conventional extruder.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a cross sectional view of a conventional tire without a conductive ring;

FIG. 2 is a cross sectional view of a tire having a slanted conductive ring;

FIG. 3 is a cross sectional view of a molding extruder for extruding a tire tread;

FIG. 4a is a perspective view illustrating a separated state of a die set according to the present invention;

FIG. 4b is a perspective view illustrating an assembled state of a die set according to the present invention;

FIG. 5a is a front view of a preform die according to the present invention;

FIG. 5b is a rear view of a preform die according to the present invention;

FIG. 5c is a perspective view of a preform die according to the present invention;

FIG. 6a is a view illustrating extrusion of a tread formed by a die set having a preform die according to the present invention; and

FIG. 6b is a view illustrating extrusion of a tread by a conventional preform die.

### DESCRIPTION OF THE PREFERRED EMBODIMENTS

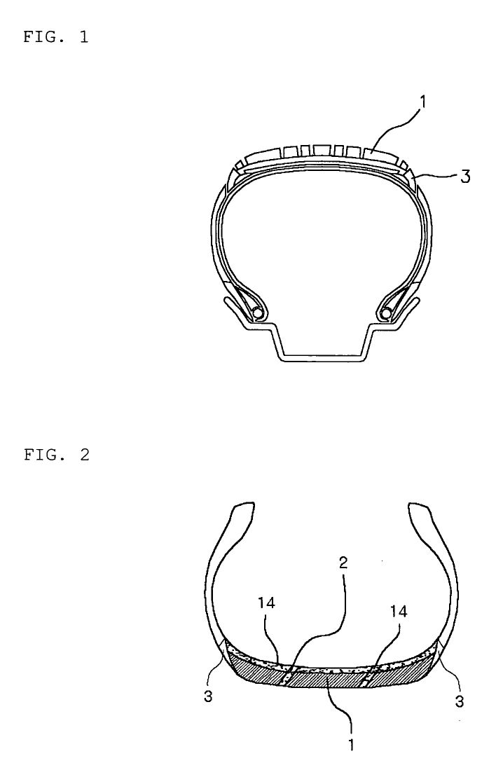

FIG. 1 is a cross sectional view of a conventional tire without a conductive ring, and FIG. 2 is a cross sectional view of a tire with a slanted conductive ring.

As shown in FIGS. 1 and 2, a tire tread portion includes three components; a cap tread, an under tread, and tread wings. Tread (i.e., the cap tread, the under tread, and the tread wings) are formed with different compositions, respectively, in order to satisfy respective performances. More particularly, since the rubber composition of the cap tread contacting the ground directly affects the performance of a tire, such as wear resistance, rotational resistance characteristics, and braking performance, a large amount of silica is used in the rubber composition of the cap tread, as described above. Also, a large amount of carbon black is used in the under tread and the conductive ring in order to discharge the accumulated static electricity and discharge the accumulated static electricity.

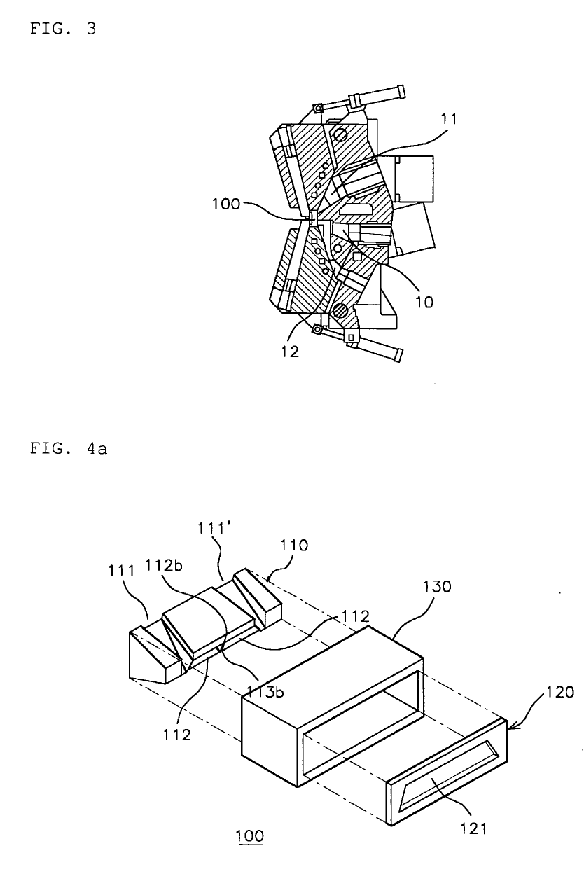

FIG. 3 is a cross sectional view of a molding extruder for molding the tread portion by extruding the cap tread, the under tread, and the tread wings simultaneously.

The tread portion is formed by simultaneously extruding the three different rubber compositions using the molding extruder shown in FIG. 3. The molding extruder includes three extruders for extruding respective compositions, and a die set 100 having a die for molding a tread portion. The die is assembled to a head section where an insert for ensuring uniform flow rate of extruded rubber, and leading edges of the three extruders, that is, a cap tread extruding port, an under tread extruding port, and tread wing extruding port meet each other. In FIG. 3, not-described reference numerals 10, 11, and 12 indicate a cap tread introducing port, an under tread introducing port, and a tread wing introducing port, respectively.

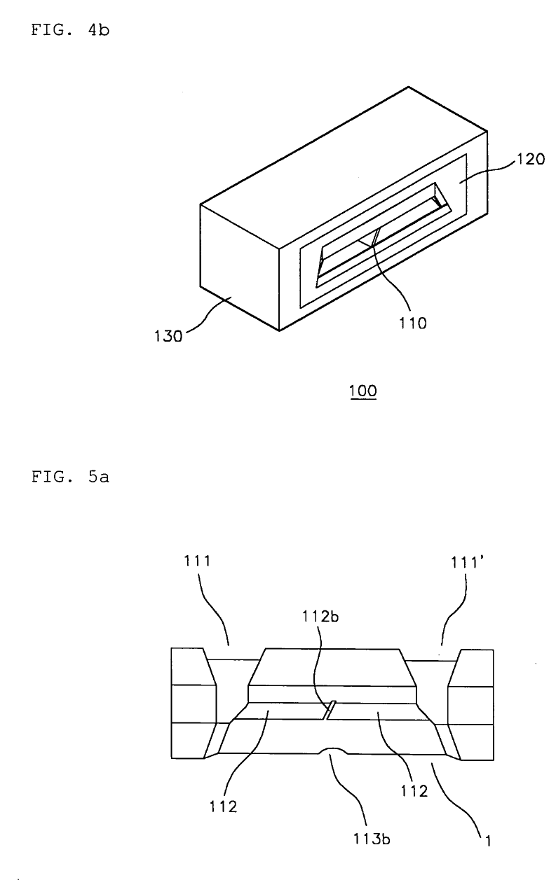

The die set 100, as shown in FIGS. 4a and 4b, includes a preform die 110 for forming a final extruded shape, a final die 120 for completing the tread portion by pressing each component of the tread portion extruded from the preform die 110, and a box-shaped cassette 130 for assembling the preform die 110 and the final die 120 into one.

As described above, in comparison with a die set for molding a conventional tread portion without a conductive ring by extrusion in the view of the components, the construction of the die set 100 including the preform die 110, the final die 120, and the cassette 130 is not different from the conventional die set. The assembled die set 100 has a cube-like shape suitable to be assembled to the head section of the molding extruder.

According to the aspects of the present invention, as shown in FIGS. 4a and 4b, the conductive ring is designed so that the conductive rubber composition, i.e., the under tread rubber composition penetrates the cap tread.

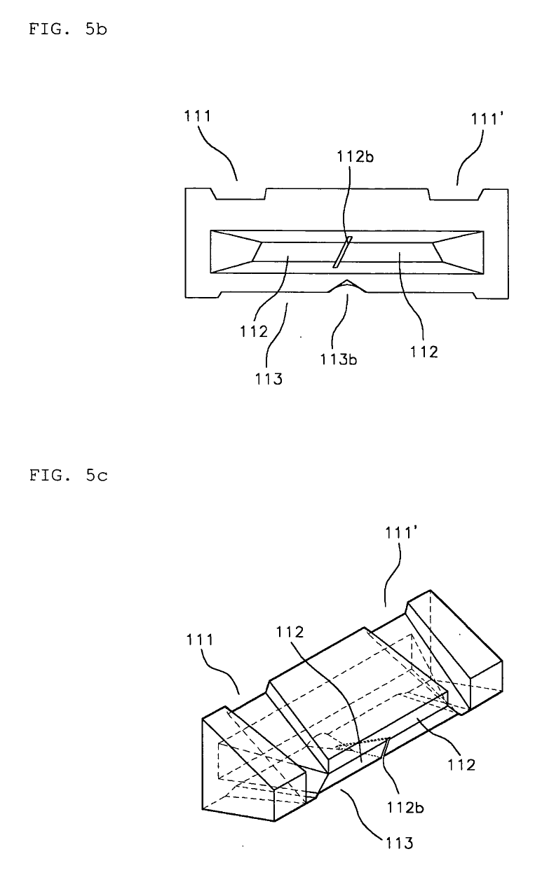

FIG. 5a is a front view of the preform die 110 according to the present invention, FIG. 5b is a rear view of a preform die 110, and FIG. 5c is a perspective view of a preform die 110.

As shown in FIGS. 4, 5a, 5b, and 5c, the preform die 110 of the present invention has a cubic shape with rectangular front and rear sides of different sizes, trapezoidal right and left sides, and trapezoidal upper and bottom sides, and is formed with two lanes of recess-shaped tread extruding passages 111 and 111′, a cap tread extruding passage 112 penetrating a center portion of the preform die 110, and a recess-shaped under tread extruding passage 113 at the bottom side of the preform die 110, respectively.

The tread wing extruding passages 111 and 111′ are formed by two lanes of recesses with a predetermined width and depth on the upper side from the front side to the rear side. The depth and width of the tread wing extruding passages 111 and 111′ decrease as the recesses run from the rear side of the preform die 110 to the front side of the preform die 110. As shown in FIGS. 5a and 5b, the cross-section of the tread wing extruding passages 111 and 111′ varies from a quadrangle with slant sidewalls to an approximate triangle near the front side of the preform die 110.

The cap tread extruding passage 112 is formed between the tread wing extruding passages 111 and 111′ and the under tread extruding passage 113 which will be described later in a quadrangle port penetrating from the front side to the rear side. The size of the rear quadrangle port of the cap tread extruding passage 112 is larger than that of the front quadrangle port of the cap tread extruding passage 112. The size of the cap tread extruding passage 112 decreases as it runs from the rear side to the front side of the preform die 110. The shape of the cap tread extruding passage 112 varies from a quadrangle at the rear side of the preform die 110 to an approximate trapezoid at the front side of the preform die 110.

The cap tread extruding passage 112 is formed with a conductive ring block 112b as a feature of the present invention. The conductive ring block 112b has a shape approximating a triangular plate, climbs from the bottom surface of the under tread extruding passage 113 to the ceiling of the under tread extruding passage 113, so that the conductive ring block 112b divides the space of the cap tread extruding passage into a right-side space and a left-side space.

The under tread extruding passage 113 is formed on the bottom side of the preform die 110 by an approximately quadrangular recess, the size of the recess decreases as it runs from the rear side to the front side while the shape thereof varies from a quadrangle to a trapezoid, and functions as a passage for extruding the under tread rubber composition. The under tread extruding passage 113 is formed with a triangular recess 113h at a rear central ceiling extended from the rear side to the front side. The triangle recess 113h varies in shape from a triangle to an arc and the depth thereof decreases nearer to the front side. The under tread extruding passage 113 meets the conductive ring block 112b at the upper side so as to form a space for guiding rubber flow to mold a conductive ring.

The approximately quadrangular final die 120 is provided at the front side of the preform die 110 and combines three semimanufactured extruded goods passed through the preform die 110, and is formed with a penetrated trapezoidal final pressing port 121 at a central portion of the final die 120 being inserted into a quadrangle recess formed on the front side of the preform die 110 when assembling the cassette 130, described later, and the preform die 110.

The cassette 130, as shown in FIGS. 4a and 4b, has a hollow opened box and is installed with the final die 120 in the front inside thereof and the preform die 110 in the rear inside thereof that the rectangular die set 100 can be constructed.

As described above, the preform die 100 according to the present invention constructs the die set 100 in cooperation with the final die 120 and the cassette 130, and is installed at the head section of the mold extruder to mold the tread portion by the extrusion.

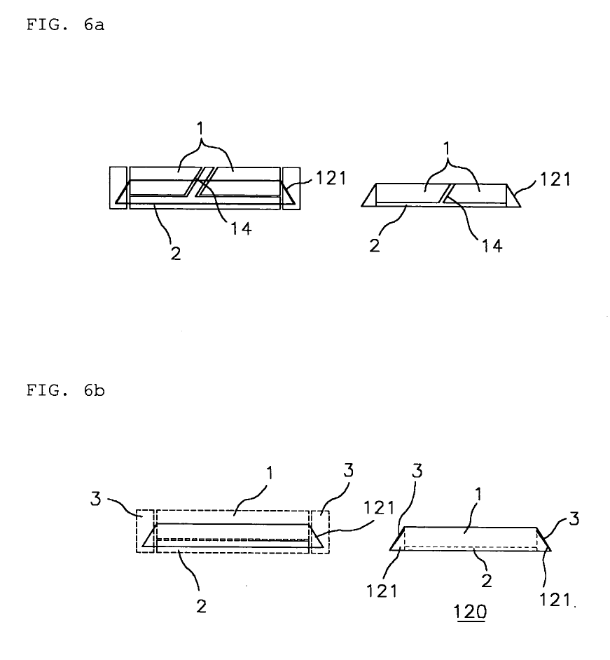

FIG. 6a is a view illustrating extruded goods of a tread molded by the die set 100 having the preform die 110 according to the present invention, and FIG. 6b is a view illustrating extruded goods of a tread produced by a conventional preform die.

Precise design of the extruding preform die 110, adjustment of extrusion amount, and viscous balance of the rubber composition are importance factors in forming the profile of the conductive ring without deterioration of the productivity in the present invention. In the present invention, the tread profile having a final conductive ring is molded by the extruder and the die as follows. The rubber independently flowing from each extruder is molded into a tread-shaped semimanufactured good when passing through the final die 120 formed with the profile after passing through the preform die 110 located at the head section of the extruder in order to mold extruded goods into the final profile (See FIG. 6a).

In other words, in the conventional art for combining the conductive rubber composition with the tread rubber composition after extruding extruded goods in each profile form individually, the dimensional stability is deteriorated and since the adhesive strength of the combined portion is weak, inferior finished goods may be manufactured.

Therefore, for the purpose of solving the above problem and of improving productivity, the present invention can improve the dimension stability by coextrusion technology for extruding a tread portion with a conductive ring by combining three semimanufactured goods in advance in the die set 100 by using the preform die 110 and the final die provided at the head section by using a well known tri-extruder. The semimanufactured tread is formed into a single semimanufactured tread portion by combining three rubber compositions, that is, side tread wings 3, a cap tread 1 contacting the ground in the finished product, an under tread 2 disposed between a belt and the cap tread 1, and a conductive ring serving as a passage for discharging static electricity.

The construction according to the present invention is a technical embodiment for the method for molding the slanted conductive ring 14 to penetrate from the under tread 2 to the cap tread 1 by changing the shape of the above-described preform die 110 for combining three rubber compositions. The rubber guided from the molding extruder (See FIG. 3) is guided into the final die 120 along each passage formed on the preform die 110, that is, the tread wing extruding passages 111 and 111′, the cap tread extruding passage 112, and the under tread extruding passage 113.

By changing the cap tread extruding passage 112 for guiding the rubber composition to mold the cap tread 1, the conductive ring block 112b for cutting a central portion of the cap tread 1 is formed at the central portion of the preform die 110 so as to cut the cap tread 1 at an angle. Hence the changed cap tread extruding passage 112 guides the rubber flow. The conductive ring 14 is molded by guiding a central rubber of the under tread 2 into a space between the divided cap tread 1 convexly. The central rubber of the under tread 2 is molded by extrusion from the triangular recess 113h formed at a central portion of the under tread extruding passage 113 for guiding the under tread rubber, that is, at the central ceiling portion of the under tread extruding passage 113 facing the cap tread extruding passage 112. The shape and size of the triangular recess 113h determine the depth of the conductive ring 14 extending and protruding from the under tread 2.

The cap tread guided by the extruder is divided in two and molded by the cap tread extruding passage 112 formed with the conductive ring block 112b, and is then guided into the final die 120, and the under tread 2 formed with the conductive ring 14 protruding upward from a central portion of the preform die 110 by the under tread extruding passage 113 having the triangular recess 113h is inserted between the divided cap tread 1 and guided into the final die 120, so that the tread portion with the conductive ring is molded by the extrusion by combining the tread 1, the under tread 2, the tread wings 3, and the conductive ring 14. FIG. 6a illustrates this operation briefly. The trapezoids depicted by bold lines in FIGS. 6a and 6b represent the final pressing passage 121 formed in the final die 120.

As described above, the preform die 110 is designed to mold the conductive ring penetrating a cap tread by a flow of the extruded under tread rubber, as well as to allow improvement of the fluidity by using a flow agent such as fatty acid, takifier, and the like, capable of increasing the flow rate of the under tread rubber composition.

The above embodiment of the preform die of the die set according to the present invention is designed to form a slant conductive ring on a tread, and the case of forming a conductive ring perpendicular to the ground is within the scope of the present invention. In other words, if the conductive ring block is not formed at an angle but is instead formed perpendicular to the cap tread extruding passage, the conductive ring perpendicularly penetrating the cap tread can be molded.

According to the present invention, the cap tread rubber composition is a rubber composition using a large amount of silica, and the under tread rubber composition is a highly conductive rubber composition using carbon black. Moreover, it is possible to improve the electric conductivity of the under tread by using the under tread rubber composition with an antistatic agent or carbon black. Since the conductive ring is formed by a changed structure, the under tread rubber composition is identical to the conductive ring rubber composition and should be compounded using a sufficiently conductive rubber composition. To ensure the sufficient conductivity, in the present invention, carbon black within the range of BET 50-150 m²/g should be contained in an amount of more than 30 phr. For the purpose of preventing the separation of the cap tread rubber composition and the conductive ring rubber composition and preventing stress acting on the conductive ring due to stress when in motion, and to improve the capability to discharge discharging static electricity by increasing contacting area with the ground, the conductive ring is formed to keep the conductive ring slanted to the tread surface by changing the preform die for the under tread. The depth of the conductive ring ranges 0.1 mm to 3 mmm. If the depth is under 0.1 mm, since the static electricity cannot be discharged sufficiently and the productivity decreases due to the difficulty of forming a perfect conductive ring during the extrusion, the depth should be equal to or greater than 0.1 mm. If the depth is equal to or greater than 3 mm, though the static electricity can be sufficiently discharged when the minimum depth is 3 mm, performance, such as braking performance on pavement, and low rotational resistance, and the like, as an advantage of the cap tread of the silica filling rubber composition, may be decreased when the depth is greater than a predetermined value and the performance may also be deteriorated due to abnormal abrasion. Further, by forming one or two conductive rings, the static electricity can be effectively discharged even in the case of bad road conditions or non-uniform abrasion. The slope forms an angle of 110 to 130 degrees. If the angle is under 110 degrees, since the load of a vehicle's body is applied vertically, the cap tread rubber may be separated and the contacting surface with the road surface decreased so that the capability of discharging static electricity is also deteriorated. If the angle is greater than 130 degrees, the productivity of the manufacturing process decreases. By providing sufficient static electricity discharging capability under 130 degrees, a finished tire having a slant conductive ring can be provided to have a volume resistivity equal to or less than 10⁷ Ωcm as a barometer of the electric conductivity of a finished tire having a slant conductive ring.

As apparent from the above description, by changing well-known extruder into the extruding preform die according to the present invention without additional devices or processes, it is possible to form the conductive ring sufficiently contacting the cap tread and fully penetrating the cap tread in the coextrusion. By forming the slant conductive ring, it is possible to prevent the conductive ring from separation from the tread due to external stress. Since the finally finished tire has a volume resistivity less than 10⁷ Ωcm, the static electricity can be discharged easily.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A die set of an extruder for molding a tire with a slant conductive ring for manufacturing a tread portion by respectively extruding and combining a cap tread, an under tread, and tread wings, the die set installed at a head section of a mold extruder having a tri-extruder for extruding a tire having a conductive ring with an angle slanted to the ground, the conductive ring protruding from the under tread of the tread portion and penetrating the cap tread, the die set comprising:
a preform die;
a final die; and
a cassette,
wherein the preform die comprises:
a conductive ring block in which a plate-shaped surface for dividing a space of a cap tread extruding passage formed in the preform die as an extruding passage of a cap tread rubber composition into a right-side space and a left-side space is formed in the cap tread extruding passage and connects a ceiling of the extruding passage and a bottom surface in a slant form; and
a triangular recess formed at a central portion of a rear ceiling of an under tread extruding passage as an extruding passage of an under tread rubber composition in an upper direction.
